(19) United States
(12) Patent Application Publication
(10) Pub. No.: US 2017/0361395 A1
(43) Pub. Date: Dec. 21, 2017

(54) METHOD FOR PLUGGING ORIFICE

(71) Applicant: Kabushiki Kaisha Toshiba, Minato-ku (JP)

(72) Inventor: Taizo TOMIOKA, Yokohama (JP)

(73) Assignee: Kabushiki Kaisha Toshiba, Minato-ku (JP)

(21) Appl. No.: 15/623,803

(22) Filed: Jun. 15, 2017

(30) Foreign Application Priority Data
Jun. 16, 2016 (JP) 2016-119584

(51) Int. Cl. B23K 20/12

(52) U.S. Cl. CPC B23K 20/1255; B23K 20/122

(57) ABSTRACT

According to one embodiment, a method is disclosed for plugging an orifice. The method can include rotating a tool including a shoulder portion and a probe pin, and inserting the probe pin into a member having an orifice. The probe pin is provided at an end portion of the shoulder portion. The method can include forming a plug portion by moving the rotating tool to traverse the orifice. The plug portion plugs the orifice.

### CROSS-REFERENCE TO RELATED APPLICATIONS

This application is based upon and claims the benefit of priority from Japanese Patent Application No. 2016-119584, filed on Jun. 16, 2016; the entire contents of which are incorporated herein by reference.

### FIELD

Embodiments relate to a method for plugging orifice.

### BACKGROUND

When friction stir welding (FSW) is used, it may be problematic that an exit hole of the friction stir welding tool (the tool) remains at the weld end. Therefore, hole-filling methods such as a method of inserting a metal plug into the hole and performing friction stir welding of the surface, a method of performing friction welding of a metal plug into the interior of the hole, a method of inserting a filling material into the hole, etc., have been proposed.

Here, due to the function or application of the member, etc., there are cases where it is necessary to plug the surface while ensuring a space inside the hole provided in the member. However, a space cannot remain in the interior of the member in conventional methods that use a member such as a metal plug, a filling material, etc., because the bottom portion of the hole has the function of receiving these members.

Therefore, it is desirable to develop technology to plug only the orifice of the recess or hole provided in the member.

### BRIEF DESCRIPTION OF THE DRAWINGS

FIG. 1 is a schematic perspective view for illustrating a friction stir welding tool;

FIG. 2 is a schematic perspective view for illustrating another friction stir welding tool according to the embodiment;

FIG. 3 is a schematic view for illustrating the friction stir welding apparatus;

FIGS. 4A to 4C are schematic cross-sectional views for illustrating the method for plugging the orifice according to the embodiment;

FIGS. 5A and 5B are photographs for illustrating the plug portion formed by the method for plugging the orifice according to the embodiment;

FIG. 6 is a photograph for illustrating a plug portion formed by laser welding;

FIG. 7 is a schematic perspective view for illustrating a liquid cooling jacket;

FIGS. 8A to 8C are schematic views for illustrating a method for manufacturing a liquid cooling jacket according to a comparative example;

FIGS. 9A to 9C are schematic views for illustrating a method for manufacturing the liquid cooling jacket using the method for plugging the orifice according to the embodiment; and

FIGS. 10A to 10E are schematic views for illustrating the method for manufacturing the liquid cooling jacket using the method for plugging the orifice according to the embodiment.

### DETAILED DESCRIPTION

According to one embodiment, a method is disclosed for plugging an orifice. The method can include rotating a tool including a shoulder portion and a probe pin, and inserting the probe pin into a member having an orifice. The probe pin is provided at an end portion of the shoulder portion. The method can include forming a plug portion by moving the rotating tool to traverse the orifice. The plug portion plugs the orifice.

Embodiments will be described below as an example with reference to the drawings. In the respective drawings, the same components are denoted by the same reference numerals, and the detailed description thereof will be omitted appropriately.

The method for plugging orifice according to the present embodiment can be performed by using the friction stir welding method. Therefore, first, the friction stir welding tool and a friction stir welding device used for the method for plugging orifice according to the present embodiment will be exemplified.

### Friction Stir Welding Tool

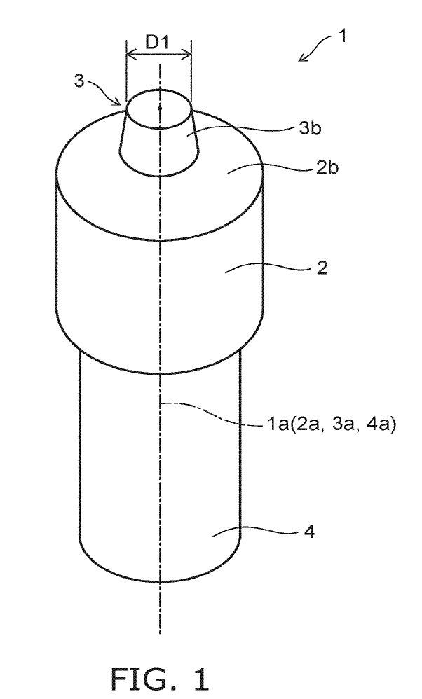

FIG. 1 is a schematic perspective view for illustrating a friction stir welding tool.

As shown in FIG. 1, the friction stir welding tool 1 (hereinbelow, called simply the tool 1) includes a shoulder portion 2, a probe pin 3, and a shank 4.

The shoulder portion 2, the probe pin 3, and the shank 4 are formed as one body.

Although the material of the shoulder portion 2, the probe pin 3, and the shank 4 is not particularly limited, it is favorable to use a material that is harder than the material of the member to be processed. The material of the shoulder portion 2, the probe pin 3, and the shank 4 may be, for example, tool steel, a tungsten alloy, a ceramic, etc.

Although the form of the shoulder portion 2 is not particularly limited, considering the anti-wear properties, the manufacturability, etc., it is desirable for the form of the shoulder portion 2 to have a cylindrical column configuration (a circular columnar configuration).

The shank 4 is the mounting portion of the tool 1 for a friction stir welding apparatus 100.

The shank 4 may have a cylindrical column configuration.

The probe pin 3 is provided at substantially the center of the shoulder portion 2.

A central axis 2a of the shoulder portion 2, a central axis 3a of the probe pin 3, and a central axis 4a of the shank 4 are positioned on the same straight line. The central axis 2a of the shoulder portion 2, the central axis 3a of the probe pin 3, and the central axis 4a of the shank 4 match a central axis 1a of the tool 1. In other words, the probe pin 3, the shoulder portion 2, and the shank 4 are provided to be concentric. However, there may be decentering that is about the size of the manufacturing fluctuation.

The probe pin 3 has a columnar configuration. The probe pin 3 has a form in which the diameter (the cross-sectional dimension) gradually decreases toward the tip. In other words, the probe pin 3 has a frustum of a right circular cone configuration (a truncated circular conical configuration). The loads on the tool 1 and the member to be processed when the tool 1 is inserted into the member can be reduced by providing the probe pin 3 with a frustum of a right circular cone configuration.

Here, if a groove having a spiral configuration is provided in a side surface 3b of the probe pin 3, plastic flow of the material can be caused in the central axis 1a direction of the tool 1 in addition to the rotation direction of the tool 1. Therefore, in a butt joining where the side faces of the members are joined together, if the tip of the probe pin 3 is inserted to a depth of 90% to 95% of the thickness of the member to be bonded, the entire region in the thickness direction of the bonding portion can be bonded by the plastic flow in the central axis 1a direction. Therefore, a groove that has a spiral configuration is provided in the side surface 3b of the probe pin 3 in the case of a general friction stir welding tool.

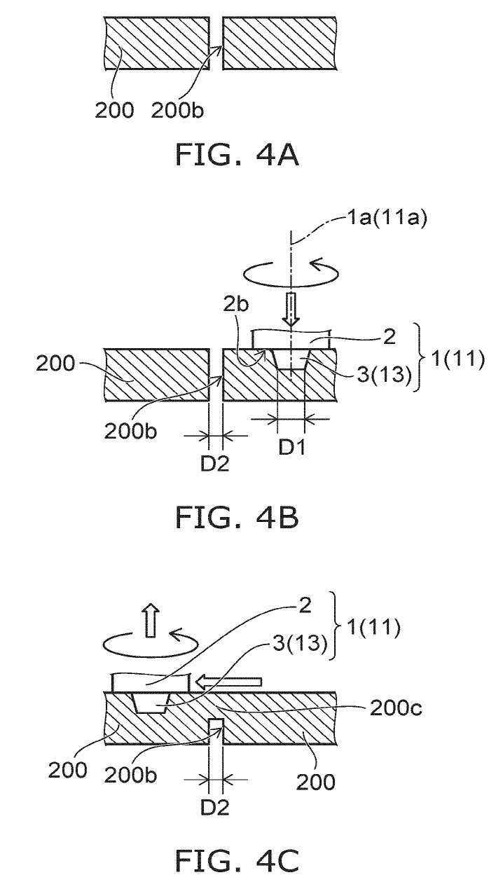

However, if the material is caused to flow plastically in the central axis 1a direction of the tool 1 when plugging a hole 200b (referring to FIGS. 4A to 4C) provided in the member, the material is introduced easily into the interior of the hole 200b, etc.; and it becomes difficult to obtain the desired plug depth with high precision. The excessively introduced material is not bonded to the wall surface of the hole 200b. Therefore, the excessively ontroduced material may separate from the bottom of the plugged hole 200b and become metal scraps. If the amount of the material introduced to the interior of the hole 200b, etc., increases, the amount of the material that can be used to plug the orifice decreases by this amount. Therefore, there is a risk that defects may occur in the surface of a plug portion 200c (referring to FIG. 4C) formed in the orifice.

Therefore, in the tool 1 according to the embodiment, a groove having a spiral configuration is not provided in the side surface 3b of the probe pin 3. In other words, the side surface 3b of the probe pin 3 is a smooth curved surface.

In a direction orthogonal to the central axis 1a of the tool 1, the diameter (the cross-sectional dimension) of the probe pin 3 is smaller than the diameter (the cross-sectional dimension) of the shoulder portion 2.

For example, the diameter (the cross-sectional dimension) of the shoulder portion 2 may be set to be not less than 2 times and not more than 3 times the diameter (the tip diameter) of the front end portion of the probe pin 3. However, the dimensional relationship between the diameter (the tip diameter) of the front end portion of the probe pin 3 and the diameter (the cross-sectional dimension) of the shoulder portion 2 is not limited to that illustrated and may be modified appropriately according to the material of the member, the processing conditions, etc.

Here, if the amount of the material that flows plastically is low, there is a risk that defects such as voids, etc., may occur in the plug portion 200c that is formed (referring to FIG. 4C).

In such a case, the amount of the material that flows plastically has a positive correlation with the volume of the probe pin 3. Therefore, the occurrence of defects such as voids, etc., in the plug portion 200c can be suppressed by correcting the volume of the probe pin 3.

The volume of the probe pin 3 can be controlled by the base diameter, the diameter (the tip diameter) of the front end portion, and the height of the probe pin 3.

In such a case, it is difficult to increase the change amount of the height of the probe pin 3 because the height is set to be about the same as the thickness of the plug portion 200c.

According to knowledge obtained by the inventor, the occurrence of defects such as voids, etc., in the plug portion 200c can be suppressed by satisfying the following formula.

D1≧2×D2

D1 is the diameter (the tip diameter) of the front end portion of the probe pin 3 in a direction orthogonal to the central axis 1a of the tool 1; and D2 is the cross-sectional dimension of the orifice of the hole 200b, a recess 200a, etc., provided in a member 200.

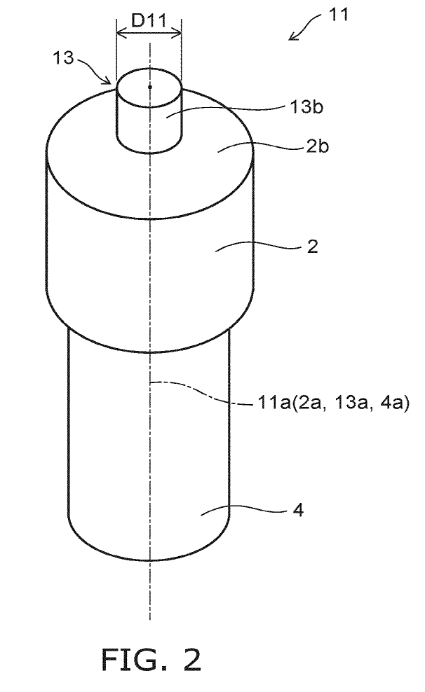

FIG. 2 is a schematic perspective view for illustrating another friction stir welding tool according to the embodiment.

As shown in FIG. 2, the friction stir welding tool 11 (hereinbelow, called simply the tool 11) includes the shoulder portion 2, a probe pin 13, and the shank 4.

The shoulder portion 2, the probe pin 13, and the shank 4 are formed as one body.

The probe pin 13 is provided at substantially the center of the shoulder portion 2.

The material of the probe pin 13 may be the same as the material of the probe pin 3 described above.

The central axis 2a of the shoulder portion 2, a central axis 13a of the probe pin 13, and the central axis 4a of the shank 4 are positioned on the same straight line. The central axis 2a of the shoulder portion 2, the central axis 13a of the probe pin 13, and the central axis 4a of the shank 4 match a central axis 11a of the tool 11. In other words, the probe pin 13, the shoulder portion 2, and the shank 4 are provided to be concentric. However, there may be decentering that is about the size of the manufacturing fluctuation.

Although the probe pin 3 has a frustum of a right circular cone configuration, the probe pin 13 has a cylindrical column configuration.

In the tool 11 according to the embodiment as well, a groove having a spiral configuration is not provided in a side surface 13b of the probe pin 13. In other words, the side surface 13b of the probe pin 13 is a smooth curved surface.

The diameter (the cross-sectional dimension) of the shoulder portion 2 may be set to be about 2 to 3 times the diameter (the tip diameter) of the front end portion of the probe pin 13. However, the dimensional relationship between the diameter (the tip diameter) of the front end portion of the probe pin 13 and the diameter (the cross-sectional dimension) of the shoulder portion 2 is not limited to that illustrated and may be modified appropriately according to the material of the member, the processing conditions, etc.

Similarly to the probe pin 3 described above, the occurrence of defects such as voids, etc., in the plug portion 200c can be suppressed by satisfying the following formula.

D11≧2×D2

D11 is the diameter (the tip diameter) of the front end portion of the probe pin 13 in a direction orthogonal to the central axis 11a of the tool 11; and D2 is the cross-sectional dimension of the orifice of the hole 200b, the recess 200a, etc., provided in the member 200.

### Friction Stir Welding Apparatus

The friction stir welding apparatus 100 will now be illustrated.

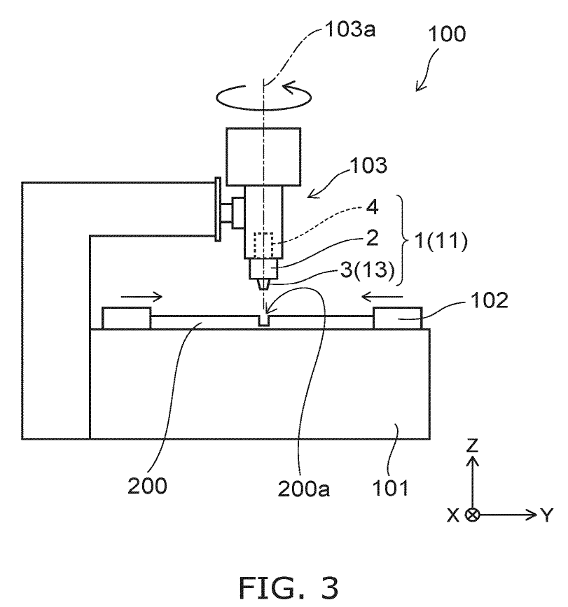

FIG. 3 is a schematic view for illustrating the friction stir welding apparatus.

Arrows X, Y, and Z in FIG. 3 illustrate three directions orthogonal to each other. For example, arrow Z illustrates a vertical direction; and arrow X and arrow Y illustrate horizontal directions.

The friction stir welding apparatus 100 shown in FIG. 3 plugs the orifice of the hole 200b, the recess 200a, etc., provided in the member 200.

The friction stir welding apparatus 100 may be mounted on a floor surface, etc.

A processing part 103 of the friction stir welding apparatus 100 may be mounted to the hand of a six-axis vertical articulated robot, etc.

As shown in FIG. 3, a placement part 101, a holder 102, and the processing part 103 are provided in the friction stir welding apparatus 100.

The member 200 is placed on the placement part 101.

The recess 200a that has an opening at the surface of the member 200, the hole 200b that pierces the thickness direction of the member 200, etc., are provided in the member 200. The recess 200a that has the opening at the surface of the member 200 is provided in the member 200 illustrated in FIG. 3.

The material of the member 200 is not particularly limited as long as plastic flow can be caused by the friction stir welding. For example, the material of the member 200 may be a metal. The metal may be, for example, aluminum, an aluminum alloy, copper, a copper alloy, titanium, a titanium alloy, magnesium, a magnesium alloy, iron, etc.

The form of the member 200 is not particularly limited. For example, the member 200 that has a plate configuration such as that illustrated in FIG. 3 may be used; and the member 200 that has a block configuration may be used.

The holder 102 holds the member 200. The configuration of the holder 102 is not particularly limited as long as the member 200 can be held. For example, the holder 102 may include a hydraulic cylinder, a control motor such as a servo motor, etc., and may hold the member 200 mechanically. The holder 102 may include an electromagnetic chuck, a vacuum chuck, etc.

The processing part 103 holds the shank 4 of the tool 1 (11).

The processing part 103 rotates the tool 1 (11) around the central axis 103a.

The processing part 103 changes the position of the rotating tool 1 (11).

For example, the processing part 103 inserts the probe pin 3 (13) into the interior of the member 200 and extracts the probe pin 3 (13) from the member 200 by changing the position in the Z-direction of the rotating tool 1 (11).

Then, the processing part 103 causes the tool 1 (11) to traverse the orifice provided in the member 200 by changing the position in the Y-direction or the X-direction of the rotating tool 1 (11).

The processing part 103 may include, for example, a control motor such as a servo motor, etc.

### Method for Plugging Orifice

A method for plugging an orifice according to the embodiment will now be illustrated.

FIGS. 4A to 4C are schematic cross-sectional views for illustrating the method for plugging the orifice according to the embodiment.

As shown in FIG. 4A, the hole 200b that pierces the member 200 in the thickness direction is provided in the member 200. In other words, the hole 200b that has an opening at the surface of the member 200 is provided in the member 200.

First, the tool 1 (11) that includes the probe pin 3 (13) having an appropriate diameter (a tip diameter) D1 (D11) of the front end portion is selected according to the cross-sectional dimension D2 of the orifice.

Namely, the tool 1 (11) that includes the probe pin 3 (13) is selected so that D1≧2×D2 (D11≧2×D2).

Then, the tool 1 (11) is rotated using the central axis 1a (11a) of the tool 1 (11) as the center of rotation.

The rotation speed of the tool 1 (11) may be appropriately set according to the diameter (the tip diameter) D1 (D11) of the front end portion of the probe pin 3 (13). In such a case, the rotation speed may be set to increase as the diameter (the tip diameter) D1 (D11) of the front end portion of the probe pin 3 (13) decreases. The rotation speed of the tool 1 (11) may be set to, for example, about 500 rpm to 15000 rpm.

Continuing as shown in FIG. 4B, the probe pin 3 (13) of the rotating tool 1 (11) is inserted into the interior of the member 200.

The probe pin 3 (13) is inserted into the vicinity of the orifice.

In such a case, it is favorable for an end portion 2b on the probe pin side of the shoulder portion 2 to be inserted about 0.1 mm to 0.2 mm into the interior of the member 200.

The angle between the central axis 1a (11a) of the tool 1 (11) and a line perpendicular to the surface of the member 200 may be set to, for example, not less than 0° and not more than 3°. This angle is set to 00 in FIG. 4B.

Then, as shown in FIG. 4C, the rotating tool 1 (11) is moved along the surface of the member 200.

The movement speed may be modified appropriately according to the material of the member 200, etc.

For example, in the case where the material of the member 200 is 6000-series aluminum, the movement speed may be set to about 100 mm/min to 200 mm/min.

The material of the member 200 on the front side of the tool 1 (11) flows plastically due to frictional heat and pressure. The plastically flowing material moves toward the rearward side of the tool 1 (11) while being stirred and kneaded as the tool 1 (11) moves. The material that moves toward the rearward side of the tool 1 (11) loses frictional heat and solidifies rapidly. Therefore, the orifice of the hole 200b is plugged by the material of the member 200. In other words, the plug portion 200c is formed by the solidification of the material moving toward the rearward side of the rotating tool 1 (11).

As described above, a groove that has a spiral configuration is not provided in the side surface 3b (13b) of the probe pin 3 (13). Therefore, the introduction of the material into the interior of the hole 200b can be suppressed when the tool 1 (11) passes through the orifice of the hole 200b. In other words, by setting the side surface of the probe pin 3 (13) to be a smooth curved surface, the introduction of the stir and kneaded material to the interior of the orifice when the rotating tool 1 (11) traverses the orifice is suppressed.

As a result, the occurrence of defects such as voids, etc., in the plug portion 200c of the orifice can be suppressed.

Also, the temperature at which the material of the member 200 flows plastically is much lower than the melting point of the material. Therefore, compared to the case where the orifice of the hole 200b is plugged by laser welding, etc., the temperature increase at the plug portion 200c vicinity can be suppressed. As a result, the occurrence of deformation and/or cracks due to thermal strain can be suppressed. Changes of the composition of the material also can be suppressed.

Then, the rotating tool 1 (11) is extracted from the member 200 after the plug portion 200c is formed.

A mark (a recess) where the probe pin 3 (13) was inserted is formed at the position where the tool 1 (11) is extracted. Therefore, the position where the tool 1 (11) is extracted is set to be a position such that the hole 200b does not communicate with the mark (the recess) remaining in the member 200. In other words, the rotating tool 1 (11) is extracted from the member 200 at a position such that the orifice does not communicate with the recess formed by extracting the rotating tool 1 (11).

Thus, the orifice of the hole 200b provided in the member 200 can be plugged. The orifice of the recess 200a provided in the member 200 also can be plugged similarly.

In such a case, the plug portion 200c is formed at the surface vicinity of the member 200. A space is formed below the plug portion 200c.

As described above, the method for plugging the orifice according to the embodiment may include the following processes:
a process of rotating the tool 1 (11) including the shoulder portion 2 and the probe pin 3 (13), and inserting the probe pin 3 (13) into the member 200 having the orifice;
a process of forming the plug portion 200c that plugs the orifice by moving the tool 1 (11) to traverse the orifice, wherein the plug portion 200c is formed by solidification of the plastically flowing material of the member 200 in the process of forming the plug portion 200c that plugs the orifice; and
a process of extracting the rotating tool 1 (11) from the member 200.

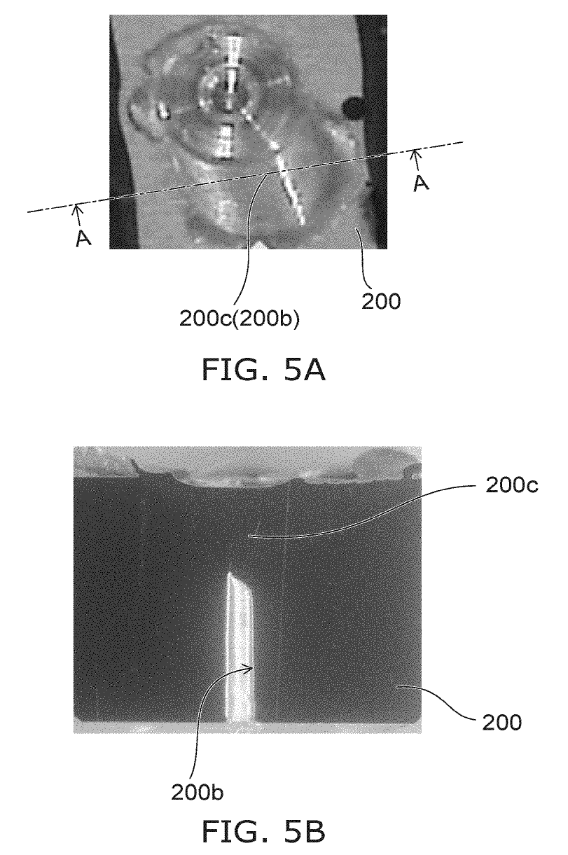

FIGS. 5A and 5B are photographs for illustrating the plug portion formed by the method for plugging the orifice according to the embodiment.

FIG. 5A is a photograph of the surface of the member 200. FIG. 5B is a photograph of line A-A′ cross section of FIG. 5A. In other words, FIG. 5B is a cross-sectional photograph of the plug portion 200c.

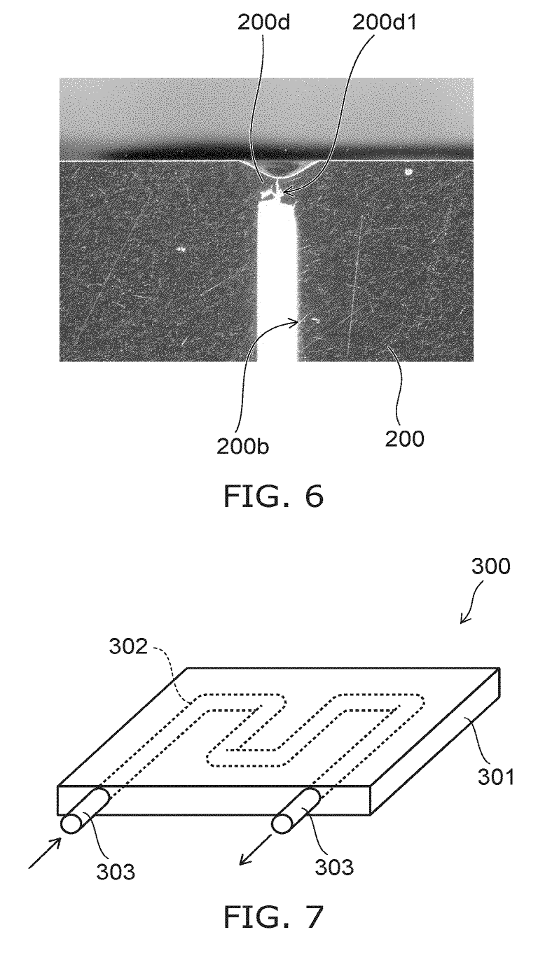

FIG. 6 is a photograph for illustrating a plug portion formed by laser welding.

Defects such as cracks 200d1, etc., occur easily in the plug portion 200d as shown in FIG. 6 in the case where the orifice of a member made of aluminum is plugged using laser welding. This is affected by the large thermal expansion coefficient and solidification contraction of aluminum.

Conversely, in the case where the orifice is plugged using the method for plugging the orifice according to the embodiment, the temperature of the plug portion 200c vicinity can be about 200° C. lower than that of laser welding. Also, solidification contraction does not occur because the material of the member does not melt. Therefore, it can be seen from FIG. 5B that the occurrence of defects such as voids, etc., in the plug portion 200c can be suppressed.

### Example

The method for plugging the orifice according to the embodiment will now be described further.

Here, the method for plugging an orifice in the manufacture of a liquid cooling jacket is described as an example. However, the applications of the method for plugging the orifice according to the embodiment are not limited to the manufacture of liquid cooling jackets.

FIG. 7 is a schematic perspective view for illustrating a liquid cooling jacket.

The liquid cooling jacket 300 may be used to cool, for example, an IGBT (Insulated Gate Bipolar Transistor) module, etc.

As shown in FIG. 7, a main body portion 301 and connection portions 303 are provided in the liquid cooling jacket 300.

The main body portion 301 has a plate configuration. The main body portion 301 is formed from a material having a high thermal conductivity. The main body portion 301 may be formed from, for example, an aluminum alloy.

A flow channel 302 in which a liquid flows is provided in the interior of the main body portion 301. The liquid may be, for example, water, etc. The flow channel 302 meanders through the interior of the main body portion 301. The two ends of the flow channel 302 have openings at a side surface of the main body portion 301.

The connection portions 303 are connected respectively to the two end portions of the flow channel 302. The connection portions 303 have tubular configurations. One end portion of the connection portion 303 is connected to the end portion of the flow channel 302. For example, the connection portion 303 may be bonded, welded, or soldered to the end portion of the flow channel 302. An external-thread screw may be provided in the end portion of the connection portion 303; an Internal-thread screw may be provided in the end portion of the flow channel 302; and the connection portion 303 may be screwed into the end portion of the flow channel 302.

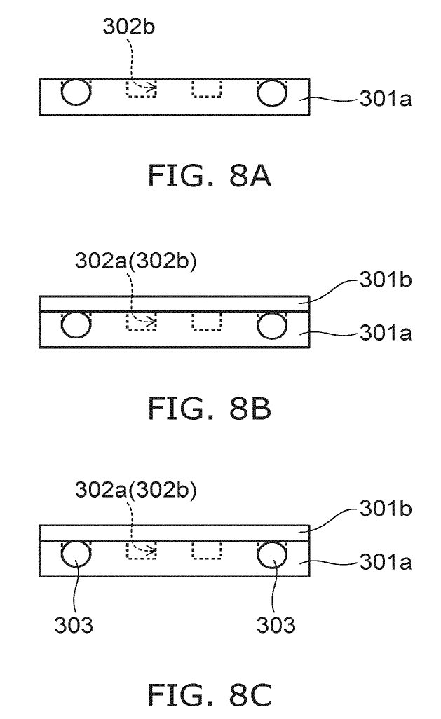

FIGS. 8A to 8C are schematic views for illustrating a method for manufacturing a liquid cooling jacket according to a comparative example.

First, as shown in FIG. 8A, a groove 302b that is used to form a flow channel 302a is formed in a base 301a having a plate configuration. In such a case, the groove 302b that has an opening at one surface of the base 301a is formed. The groove 302b meanders. The groove 302b may be formed using, for example, end milling, etc. Also, holes, internal-thread screws, etc., for connecting the connection portions 303 are formed in the two ends of the groove 302b.

Then, as shown in FIG. 8B, a lid 301b is connected to the surface of the base 301a where the groove 302b has the opening. The lid 301b may be bonded, welded, or soldered to the base 301a. Also, the lid 301b may be fastened with screws to the base 301a with a sealant interposed. The space that is defined by the groove 302b and the lid 301b becomes the flow channel 302a. The main body portion is formed by connecting the base 301a and the lid 301b.

Continuing as shown in FIG. 8C, the connection portions 303 are connected respectively to the two end portions of the flow channel 302a.

Thus, a liquid cooling jacket that includes the flow channel 302a meandering through the interior of the main body portion can be manufactured.

However, according to the method for manufacturing the liquid cooling jacket according to the comparative example, the cross-sectional configuration of the flow channel 302a in a direction orthogonal to the direction in which the flow channel 302a extends is a quadrilateral. Therefore, the pressure loss is large at the connection portion between the connection portion 303 having the circular cross section and the flow channel 302a having the quadrilateral cross section. Also, there is a risk that heat transfer may be obstructed at the interface between the base 301a and the lid 301b. Therefore, there is a risk that the performance of the liquid cooling jacket may be poor. Also, more complex manufacturing processes, higher manufacturing costs, etc., may be caused because the base 301a and the lid 301b are necessary.

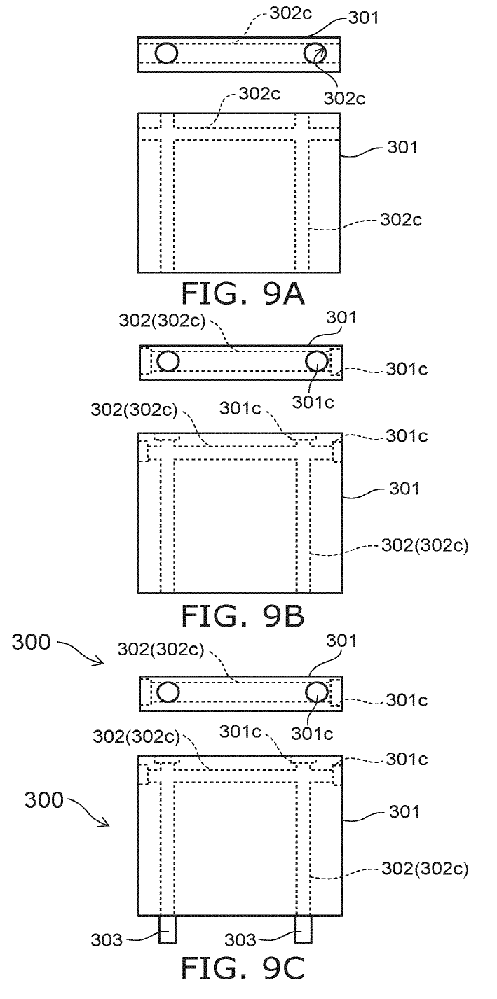

FIGS. 9A to 9C are schematic views for illustrating a method for manufacturing the liquid cooling jacket using the method for plugging the orifice according to the embodiment.

In the drawings of FIGS. 9A to 9C, the drawing on the upper side is a side view; and the drawing on the lower side is a plan view.

First, as shown in FIG. 9A, multiple through-holes 302c that are used to form the flow channel 302 are formed in the main body portion 301 having a plate configuration. In such a case, the direction in which some of the through-holes 302c extend crosses the direction in which the remaining through-holes 302c extend. In FIG. 9A, the direction in which two through-holes 302c extend crosses the direction in which one through-hole 302c extends. The through-holes 302c may be formed using, for example, drilling, etc.

Then, as shown in FIG. 9B, the orifices of the through-holes 302c are plugged using the method for plugging the orifice according to the embodiment. The flow channel 302 is formed by plugging the orifices of the through-holes 302c. In such a case, the orifices where the connection portions 303 are connected are not plugged. Plug portions 301c are formed at the plugged orifices.

Continuing as shown in FIG. 9C, the connection portions 303 are connected respectively to the two end portions of the flow channel 302.

Thus, the liquid cooling jacket 300 that includes the flow channel 302 meandering through the interior of the main body portion 301 can be manufactured.

According to the method for manufacturing the liquid cooling jacket illustrated in FIGS. 9A to 9C, the cross-sectional configuration of the flow channel 302 in a direction orthogonal to the direction in which the flow channel 302 extends is a circle. Therefore, the pressure loss at the connection portion between the connection portion 303 having the circular cross section and the flow channel 302 having the circular cross section can be reduced. The obstruction of the heat transfer can be suppressed because the main body portion 301 in which the flow channel 302 is formed has an integral structure. Therefore, the performance of the liquid cooling jacket can be improved. Also, simpler manufacturing processes, lower manufacturing costs, etc., can be realized.

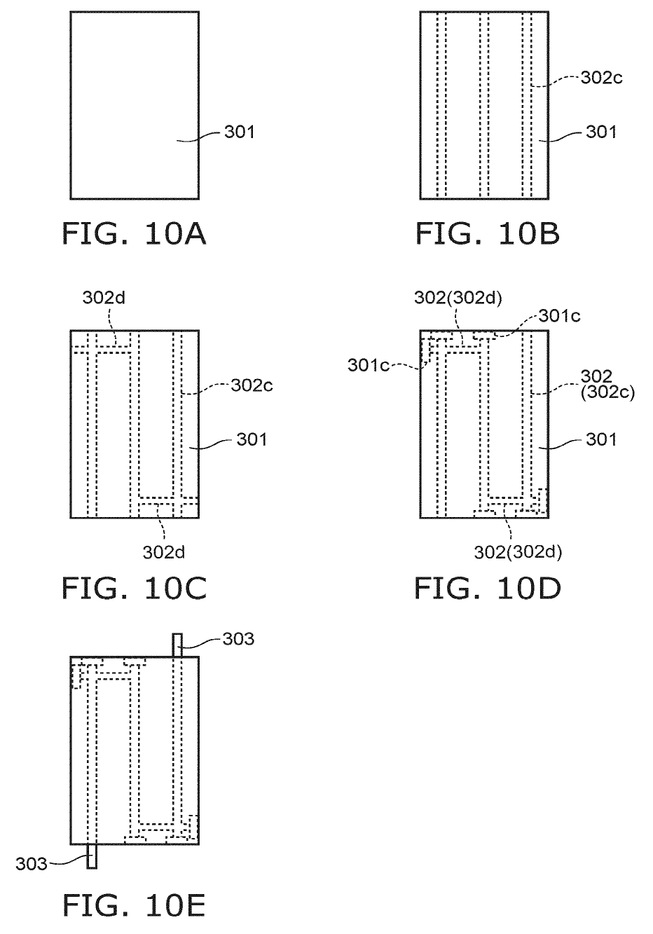

FIGS. 10A to 10E are schematic views for illustrating the method for manufacturing the liquid cooling jacket using the method for plugging the orifice according to the embodiment.

FIGS. 10A to 10E are plan views.

The main body portion 301 has a plate configuration as shown in FIG. 10A.

First, as shown in FIG. 10B, the multiple through-holes 302c that pierce the region between mutually-opposing side surfaces of the main body portion 301 are formed. The multiple through-holes 302c may be formed to be parallel to each other. Three through-holes 302c are formed in FIG. 10B. The through-holes 302c can be formed using, for example, drilling, etc.

Then, as shown in FIG. 10C, holes 302d that extend in a direction crossing the direction in which the through-holes 302c extend are formed. In such a case, two through-holes 302c are linked by one hole 302d. The holes 302d may be formed using, for example, drilling, etc.

Then, as shown in FIG. 10D, the orifices of the through-holes 302c and the orifices of the holes 302d are plugged using the method for plugging the orifice according to the embodiment. The flow channel 302 is formed by plugging the orifices of the through-holes 302c and the orifices of the holes 302d. In such a case, the orifices where the connection portions 303 are connected are not plugged. The plug portions 301c are formed at the plugged orifices.

Then, as shown in FIG. 10E, the connection portions 303 are connected respectively to the two end portions of the flow channel 302.

Thus, the liquid cooling jacket 300 that includes the flow channel 302 meandering through the interior of the main body portion 301 can be manufactured.

According to the method for manufacturing the liquid cooling jacket illustrated in FIGS. 10A to 10E, effects similar to those of the method for manufacturing the liquid cooling jacket illustrated in FIGS. 9A to 9C can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A method for plugging an orifice, comprising:
rotating a tool including a shoulder portion and a probe pin, and inserting the probe pin into a member having an orifice, the probe pin being provided at an end portion of the shoulder portion; and
forming a plug portion by moving the rotating tool to traverse the orifice, the plug portion plugging the orifice.

2. The method according to claim 1, wherein a diameter of a front end portion of the probe pin in a direction orthogonal to a central axis of the tool is not less than 2 times a cross-sectional dimension of the orifice.

3. The method according to claim 1, wherein the probe pin has a cylindrical column configuration or a frustum of a right circular cone configuration, and a side surface of the probe pin is a smooth curved surface.

4. The method according to claim 1, wherein the orifice is an opening of a recess or hole formed in the member.

5. The method according to claim 1, wherein a diameter of the shoulder portion is not less than 2 times and not more than 3 times a diameter of a front end portion of the probe pin.

6. The method according to claim 1, wherein a rotation speed of the tool is not less than 500 rpm and not more than 15000 rpm.

7. The method according to claim 1, wherein the probe pin is inserted into a surface of the member at a vicinity of the orifice.

8. The method according to claim 1, wherein in the inserting of the probe pin into the member, an end portion on the probe pin side of the shoulder portion is inserted into the member to cause a distance between a surface of the member and the end portion on the probe pin side of the shoulder portion to be not less than 0.1 mm and not more than 0.2 mm.

9. The method according to claim 1, wherein an angle between a central axis of the tool and a line perpendicular to a surface of the member is not less than 0° and not more than 3°.

10. The method according to claim 1, wherein the rotating tool is moved along a surface of the member.

11. The method according to claim 1, wherein
the member includes aluminum, and
a movement speed of the tool is not less than 100 mm/min and not more than 200 mm/min.

12. The method according to claim 1, wherein a material of the member flows plastically at a front side of the rotating tool when the rotating tool is caused to move.

13. The method according to claim 12, wherein the plastically flowing material moves, when the rotating tool is caused to move, toward a rearward side of the rotating tool while being stirred and kneaded.

14. The method according to claim 13, wherein the plug portion is formed by solidification of the material moving toward the rearward side of the rotating tool.

15. The method according to claim 1, further comprising extracting the rotating tool from the member after the plug portion is formed.

16. The method according to claim 15, wherein the rotating tool is extracted from the member at a position where the orifice does not communicate with a recess formed by the extracting of the rotating tool.

17. The method according to claim 1, wherein the plug portion is formed at a surface vicinity of the member.

18. The method according to claim 1, wherein a space is formed below the plug portion.

19. The method according to claim 13, wherein an Introduction of the stirred and kneaded material into an interior of the orifice when the rotating tool traverses the orifice is suppressed by setting a side surface of the probe pin to be a smooth curved surface.

20. The method according to claim 1, wherein the member includes at least one of aluminum, an aluminum alloy, copper, a copper alloy, titanium, a titanium alloy, magnesium, a magnesium alloy, or iron.
